(19) United States
(12) Patent Application Publication
(10) Pub. No.: US 2009/0200155 A1
(43) Pub. Date: Aug. 13, 2009

(54) AIR PURIFYING VACUUM CLEANER SYSTEM

(76) Inventor: Giovanni Cuffaro, Laval (CA)

Correspondence Address: BUCHANAN, INGERSOLL & ROONEY PC, POST OFFICE BOX 1404, ALEXANDRIA, VA, 22313-1404, US

(21) Appl. No.: 12/298,148

(22) PCT Filed: Apr. 25, 2007
(86) PCT No.: PCT/CA07/00692

§ 371 Date: Oct. 23, 2008

(30) Foreign Application Priority Data
Apr. 28, 2006 (CA) 2545168

(51) Int. Cl. B01D 53/34; A47L 9/10; B01D 50/00

(52) U.S. Cl. 204/157.3; 15/353; 96/224

(57) ABSTRACT

An air purifying system for a vacuum cleaner. An airflow reduction chamber is insertable along an airflow passage of the vacuum cleaner so that air pumped by the vacuum cleaner passes in the airflow reduction chamber prior to being released out in the open. The airflow chamber has an air inlet and an air outlet and an inner wall extending therebetween. An air deflector plate is positioned in front of one of the air inlet and the air outlet inside the airflow reduction chamber. A UV lamp of a type emitting radiations killing germs and bacteria extends inside the airflow reduction chamber. At least a portion of the inner wall of the air chamber at a level of the UV lamp has a surface reflective to UV radiations emitted by the UV lamp. A control circuit controls operation of the UV lamp.

### FIELD OF THE INVENTION

The present invention relates to vacuum cleaners, and more particularly to an air purifying vacuum cleaner system and a related method.

### BACKGROUND

Almost any household has a vacuum cleaner. Even though filters such as HEPA® filters help reducing the amount of dust, germs and other particles coming out of the exhaust of the vacuum cleaner during use, there still remains a considerable amount which passes through the filter and is rejected in the air surrounding the vacuum cleaner. Also, clouds of dust, germs and other particles are often expelled in the air during manipulations such as when changing the dust bag, the filter or emptying the vacuum container. Vacuum cleaners provide prolific environments for germs and bacteria. All of the aforesaid situations may cause health problems, especially for those who have allergies. It would therefore be desirable to at least kill germs and bacteria in vacuum cleaners so that air rejected by their exhaust or particles in suspension in the air after manipulations of the vacuum cleaners is purified and safer for health.

### SUMMARY

An object of the invention is to provide a purifying system for a vacuum cleaner which is capable of killing germs and bacteria.

Another object of the invention is to provide such a system which may be installed in central type and mobile type of vacuum cleaners.

Another object of the invention is to provide such a system which is retrofittable in existing vacuum cleaners.

A further object of the invention is to provide a method of purifying air in a vacuum cleaner which is capable of killing germs and bacteria.

According to one aspect of the present invention, there is provided an air purifying system for a vacuum cleaner, comprising:
an airflow reduction chamber insertable along an airflow passage of the vacuum cleaner so that air pumped by the vacuum cleaner passes in the airflow reduction chamber prior to being released out in the open, the airflow chamber having an air inlet, an air outlet, and an inner wall extending between the air inlet and the air outlet;
an air deflector plate positioned in front of one of the air inlet and the air outlet inside the airflow reduction chamber;
a UV lamp extending inside the airflow reduction chamber on a side of the air deflector plate opposite to said one of the air inlet and the air outlet, the UV lamp being of a type emitting radiations killing germs and bacteria, at least a portion of the inner wall of the airflow reduction chamber extending at a level of the UV lamp having a surface reflective to the radiations emitted by the UV lamp; and
a control circuit for controlling operation of the UV lamp.

According to another aspect of the present invention, there is provided a method of purifying air in a vacuum cleaner, comprising the steps of:
creating an airflow reduction chamber along an airflow passage of the vacuum cleaner so that air pumped by the vacuum cleaner passes in the airflow reduction chamber prior to being released out in the open, the airflow chamber having an air inlet, an air outlet, and an inner wall extending between the air inlet and the air outlet;
producing an airflow reduction inside the airflow reduction chamber by positioning an air deflector plate in front of one of the air inlet and the air outlet inside the airflow reduction chamber;
controlling emission of radiations capable of killing germs and bacteria inside the airflow reduction chamber using a UV lamp extending inside the airflow reduction chamber on a side of the air deflector plate opposite to said one of the air inlet and the air outlet; and
increasing an effect of the radiations emitted by the UV lamp by reflection of the radiations inside the airflow reduction chamber against at least a surface portion of the inner wall of the airflow reduction chamber extending at a level of the UV lamp.

### BRIEF DESCRIPTION OF THE DRAWINGS

A detailed description of preferred embodiments will be given herein below with reference to the following drawings, in which like numbers refer to like elements:

FIG. 1 is a schematic diagram of a purifying system installed in a central vacuum cleaner.

FIG. 2 is a schematic diagram of a purifying system vertically installed at an air inlet of a central vacuum cleaner.

FIG. 3 is a schematic diagram of a purifying system horizontally installed at an air inlet of a central vacuum cleaner.

FIG. 4 is a schematic diagram of a purifying system installed at an air exhaust of a mobile vacuum cleaner.

### DETAILED DESCRIPTION OF THE PREFERRED EMBODIMENTS

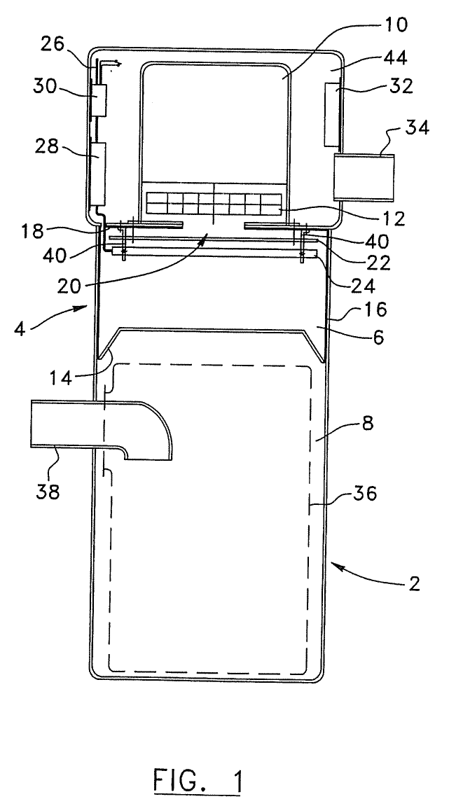

Referring to FIG. 1, there is shown a central vacuum cleaner 2 equipped with a purifying system 4 in accordance with the present invention. The purifying system 4 comprises an airflow reduction chamber 6 which, in the illustrated case, extend between a dust chamber 8 and a motor chamber 10 of the vacuum cleaner 2. The purpose of the airflow reduction chamber 6 is to reduce the speed of the air pumped in (or out) by the motor 12 of the vacuum cleaner 2. The airflow reduction chamber 6 can be formed of an air filter 14 communicating with the dust chamber 8 of the vacuum cleaner 2, followed by a peripheral side wall 16 and a back wall 18 having an opening 20 communicating with the motor chamber 10. In that case, the air filter 14 defines an inlet for the airflow reduction chamber 6 while the opening 20 defines an outlet of the airflow reduction chamber 6.

The purifying system 4 has an air deflector plate 22 extending in the airflow reduction chamber 6 in front of the opening 20, preventing air to pass directly from the dust chamber 8 to the motor chamber 10 and thus reducing the airflow. The air deflector plate 22 also has the effect of building up an air cushion in the airflow reduction chamber 6.

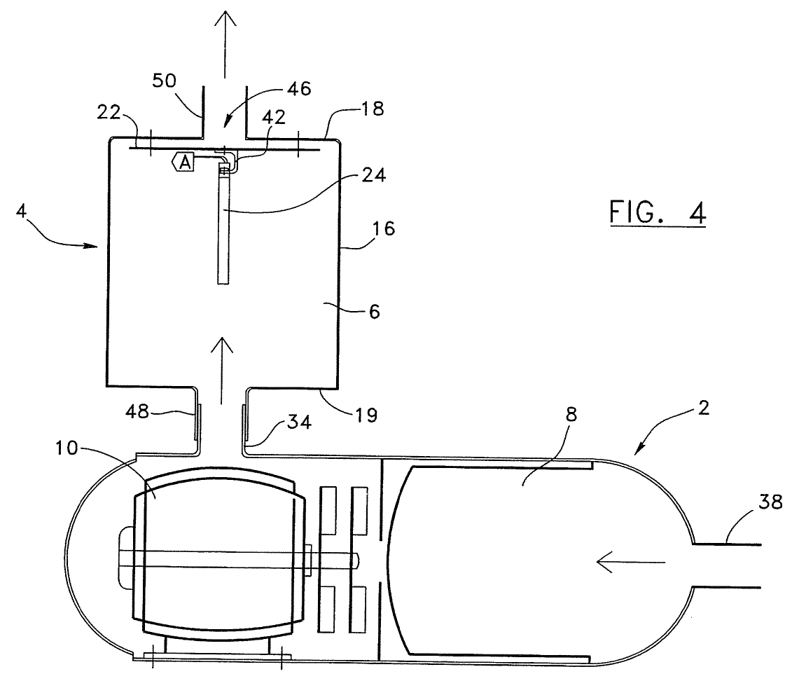

The purifying system also has a UV lamp 24 extending in the airflow reduction chamber 6, in front of the air deflector plate 22, in order to kill germs and bacteria in the circulating air inside the air reduction chamber 6. In order to increase the effect of the UV radiations in the airflow reduction chamber 6, the peripheral side wall 16, the back wall 18, the front wall 19 (as shown in FIG. 4) and/or the air deflector plate 24 preferably have UV reflective surfaces on the inner side of the airflow reduction chamber 6, thereby reflecting UV radiations emitted by the UV lamp 24 inside the airflow reduction chamber 6. The reflective surface(s) may cover only certain inner portions of the airflow reduction chamber 6, at a level of the UV lamp 24, i.e. on a side of the airflow reduction chamber 6 where the UV lamp 24 extends with respect to the side of the airflow reduction chamber 6 behind the air deflector plate 22. The UV lamp 24 may be such that it also generates ozone which, even if in small amount, is a powerful disinfecting agent. The UV lamp 24 can be connected to the power line 26 of the vacuum cleaner 2 through a ballast 28 and a relay switch 30 controlled by the motor circuitry 32 so as to be switched on and off as a function of the on and off state of the vacuum cleaner 2. Any other suitable circuit arrangement may be used if needed, for example a manual switch or other kinds of switching circuitry, preferably operating in conjunction with the operating state of the vacuum cleaner 2.

The airflow reduction in the airflow reduction chamber 6 ensures that the air flowing from the dust chamber 8 to the motor chamber 10 will remain for a sufficient length of time in the airflow reduction chamber 6 in order to kill most if not all of the germs and bacteria contained in the air, prior to its release through the exhaust 34 of the vacuum cleaner 2 after passage in a purified air chamber 44 receiving the air pumped in by the motor 12. The air deflector plate 22 preferably extends generally transversely to and near the opening 20 as in the illustrated case. The airflow reduction rate may be adjusted according to the rating of the UV lamp 24, by changing the size of the air deflector plate 22, or by changing the space or angle between the air reflector plate 22 and the back wall 18.

The UV lamp 24 may be formed of a single or multiple UV bulbs, straight, circular, “C” or “U”-shaped, mounted on brackets 40 fastened to the back wall 18 and which may also be used to support the air deflector plate 22. The UV lamp 24 should be of germicidal, bactericidal, UVC or another type capable of emitting radiations that kill germs and bacteria. Any other suitable bracket arrangement may be used to support the UV lamp 24 and the air deflector plate 22 inside the airflow reduction chamber 6, if desired.

As seen in FIG. 1, the purifying system will be retrofittable for a large number of models of vacuum cleaners, with or without a dust bag 36 such as a HEPA® bag receiving the air pumped from the air inlet 38 by the motor 12 of the vacuum cleaner 2.

The purpose of the air filter 14 is mainly to filter out an amount of particles contained in the air. It may be formed of a HEPA® filter if desired. As a result of the filter 14, less dust enters in the airflow reduction chamber 4. The filter 14 is however optional and can be removed or omitted if desired.

In the illustrated configuration, the airflow reduction chamber 6 has a size fitting inside the dust chamber 8 and a form cooperating with a configuration of the dust chamber 8 so that the air pumped by the vacuum cleaner 2 is forced to pass through the airflow reduction chamber 6. In this configuration, the inner wall 16 of the airflow reduction chamber 6 may be directly provided by the inner wall of dust chamber 8 if desired, in which case reflection of the UV radiation inside the airflow reduction chamber 8 can be achieved by affixing a UV reflecting sheet all around against the inner wall of the dust chamber 8 at the level of the UV lamp 24.

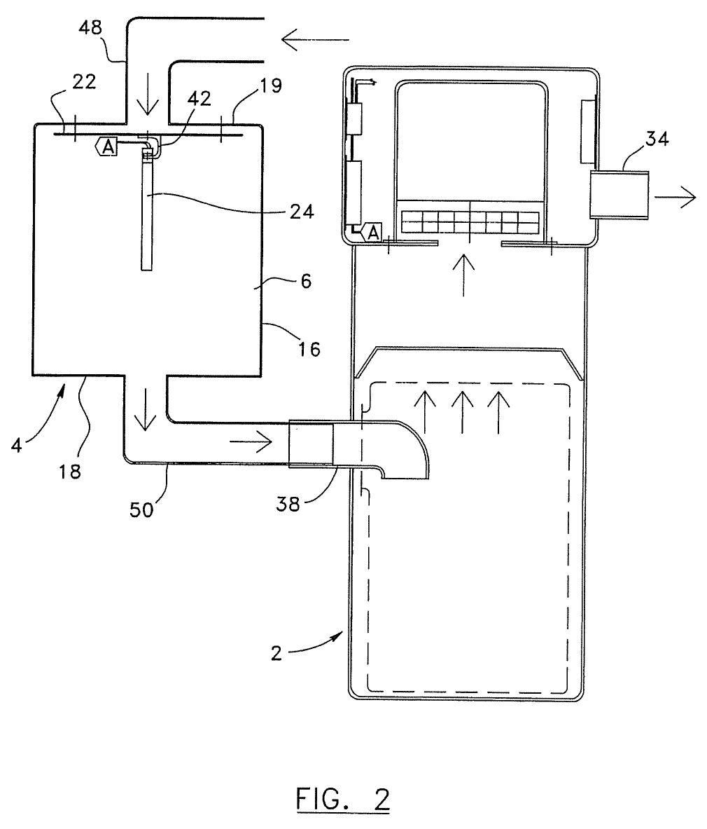

Referring to FIG. 2, if preferred or depending on the model of the vacuum cleaner 2, the purifying system 4 may be installed at the air inlet 38, outside the vacuum cleaner 2. In such a case, the airflow reduction chamber 6 may be formed by an enclosure having for example a front wall 19, a peripheral side wall 16 and a back wall 18, with the front and back walls 19, 18 having openings forming the inlet and outlet of the airflow reduction chamber 6. The air deflector plate 22 may be positioned on the inlet side of the airflow reduction chamber 6, and the UV lamp 24 may be fastened to the air deflector plate 22 through a mounting bracket 42 so as to extend perpendicularly to the air deflector plate 22, through the airflow reduction chamber 6, instead of extending alongside the deflector plate 22 as in FIG. 1.

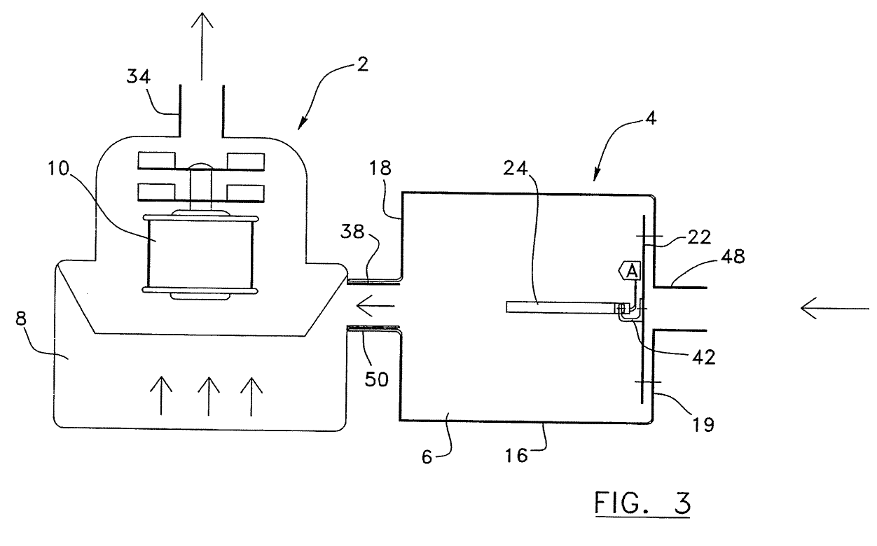

The purifying system 4 may be installed vertically on a side of the vacuum cleaner 2 as shown in FIG. 2, or horizontally as shown in FIG. 3.

Referring to FIG. 4, again if preferred or depending on the model of the vacuum cleaner 2, the purifying system 4 may be installed at the air exhaust 34. Such an installation may particularly be easier to achieve for mobile types of vacuum cleaners 2 since there is generally not much space left between the dust chamber 8 and the motor chamber 10 (the same applies to the embodiments shown in FIGS. 2 and 3). In such case, the air deflector plate 22 is preferably positioned in front of an exhaust opening 46 in the far end wall 18 of the airflow reduction chamber 6 while the UV lamp 24 extends perpendicularly to the air deflector plate 22, through the airflow reduction chamber 6.

The inlet and the outlet of the airflow reduction chamber 6 may be provided with adapters 48, 50 for facilitating the coupling of the purifying system 4 to the vacuum cleaner 2, for example to the air inlet 38 (as shown in FIGS. 2 and 3) or to the air outlet 34 of the vacuum cleaner 2.

Referring to FIGS. 1 to 4, as it can be understood from the above, purification of air in the vacuum cleaner 2 can be achieved by creating an airflow reduction chamber 6 along an airflow passage of the vacuum cleaner 2 so that air pumped by the vacuum cleaner 2 passes in the airflow reduction chamber 6 prior to being released out in the open. An airflow reduction is produced inside the airflow reduction chamber 6 by positioning an air deflector plate 22 inside the airflow reduction chamber 6 in front of its air inlet or its air outlet. Emission of radiations capable of killing germs and bacteria inside the airflow reduction chamber 6 is controlled using a UV lamp 24 extending inside the airflow reduction chamber 6 on a side of the air deflector plate 22 opposite to the air inlet or air outlet of the airflow reduction chamber 6 in front of which the air deflector plate 22 is positioned. An effect of the radiations emitted by the UV lamp 24 is increased by reflection of the radiations inside the airflow reduction chamber 6 against at least a surface portion of the inner wall 16 of the airflow reduction chamber 6 extending at a level of the UV lamp 24.

While embodiments of the invention have been illustrated in the accompanying drawings and described above, it will be evident to those skilled in the art that modifications may be made therein without departing from the essence of this invention. Such modifications are considered as possible variants comprised in the scope of the invention.

1. An air purifying system for a vacuum cleaner, comprising:
an airflow reduction chamber insertable along an airflow passage of the vacuum cleaner so that air pumped by the vacuum cleaner passes in the airflow reduction chamber prior to being released out in the open, the airflow chamber having an air inlet, an air outlet, and an inner wall extending between the air inlet and the air outlet;
an air deflector plate positioned in front of one of the air inlet and the air outlet inside the airflow reduction chamber;
a UV lamp extending inside the airflow reduction chamber on a side of the air deflector plate opposite to said one of the air inlet and the air outlet, the UV lamp being of a type emitting radiations killing germs and bacteria, at least a portion of the inner wall of the airflow reduction chamber extending at a level of the UV lamp having a surface reflective to the radiations emitted by the UV lamp; and
a control circuit for controlling operation of the UV lamp.

2. The air purifying system according to claim 1, wherein the air inlet of the airflow reduction chamber comprises an air filter.

3. The air purifying system according to claim 2, wherein the air filter comprises a HEPA® filter.

4. The air purifying system according to claim 1, wherein the UV lamp extends substantially perpendicularly to the air deflector plate.

5. The air purifying system according to claim 1, wherein the UV lamp extends substantially alongside the air deflector plate.

6. The air purifying system according to claim 1, wherein the UV lamp comprises a number of UV bulbs.

7. The air purifying system according to claim 1, wherein the UV lamp has a circuit arrangement connectable to a power line of the vacuum cleaner.

8. The air purifying system according to claim 7, wherein the circuit arrangement comprises a ballast and a relay switch controlled by a motor circuitry of the vacuum cleaner.

9. The air purifying system according to claim 1, wherein the air deflector plate has a UV reflective surface on a side of the UV lamp.

10. The air purifying system according to claim 1, wherein the air deflector plate extends substantially transversely to and near said one of the air inlet and the air outlet of the airflow reduction chamber.

11. The air purifying system according to claim 1, wherein the airflow reduction chamber is provided with a bracket arrangement projecting inside the chamber and supporting the UV lamp and the air deflector plate.

12. The air purifying system according to claim 1, wherein the airflow reduction chamber has a size fitting inside a dust chamber of the vacuum cleaner and a form cooperating with a configuration of the dust chamber so that the air pumped by the vacuum cleaner is forced to pass through the airflow reduction chamber.

13. The air purifying system according to claim 1, wherein at least one of the inlet and the outlet of the airflow reduction chamber comprises an adapter for coupling to one of an air inlet and an air outlet of the vacuum cleaner outside of the vacuum cleaner.

14. The air purifying system according to claim 13, wherein the airflow reduction chamber is formed by an enclosure having a front wall, a peripheral side wall and a back wall, the front wall having an opening forming the inlet, and the rear wall having an opening forming the outlet.

15. A method of purifying air in a vacuum cleaner, comprising the steps of:
creating an airflow reduction chamber along an airflow passage of the vacuum cleaner so that air pumped by the vacuum cleaner passes in the airflow reduction chamber prior to being released out in the open, the airflow chamber having an air inlet, an air outlet, and an inner wall extending between the air inlet and the air outlet;
producing an airflow reduction inside the airflow reduction chamber by positioning an air deflector plate in front of one of the air inlet and the air outlet inside the airflow reduction chamber;
controlling emission of radiations capable of killing germs and bacteria inside the airflow reduction chamber using a UV lamp extending inside the airflow reduction chamber on a side of the air deflector plate opposite to said one of the air inlet and the air outlet; and
increasing an effect of the radiations emitted by the UV lamp by reflection of the radiations inside the airflow reduction chamber against at least a surface portion of the inner wall of the airflow reduction chamber extending at a level of the UV lamp.
